(19) United States
(12) Patent Application Publication
(10) Pub. No.: US 2007/0255903 A1
(43) Pub. Date: Nov. 1, 2007

(54) Device, system and method of accessing a memory

(76) Inventors: Meir Tsadik, Hod-Hasharon (IL); Oded Norman, Pardesia (IL); Ron Gabor, Raanana (IL)

Correspondence Address: PEARL COHEN ZEDEK LATZER, LLP, 1500 BROADWAY, 12TH FLOOR, NEW YORK, NY, 10036, US

(21) Appl. No.: 11/414,240

(22) Filed: May 1, 2006

(51) Int. Cl. G06F 12/00; G06F 13/00

(52) U.S. Cl. 711/118; 711/154

(57) ABSTRACT

Devices, systems and methods of accessing a memory. For example, an apparatus includes: at least one buffer to store a data line read from a memory; and gatherer to store at least a portion of said data line and at least a portion of a previously read data line stored in said at least one buffer.

### BACKGROUND OF THE INVENTION

In the field of computing, a processor core may include one or more execution units (EUs) able to execute micro-operations (“u-ops”). Utilization of multiple EUs may require a high memory bandwidth. For example, in order to utilize three EUs, it may be required to read six operands from a local memory or a cache memory.

Data processing, for example, convolution, may require that a large amount of data be read and gathered from the local or cache memory in order to form a single instruction multiple data (SIMD) word for processing. Data may be read and gathered, for example, from non-consecutive memory portions; this may include, for example, reading data which may not be required for forming the SIMD word for processing. For example, in order to gather nine consecutive four-byte words required for forming two SIMD operands from the local or cache memory (e.g., having 64 of 128 bytes per memory line), it may be required to read one or two memory lines (e.g., 64 bytes or 128 bytes), and only 36 bytes out of the 64 or 128 bytes read may be used to form the two SIMD operands.

In some computing systems, the high memory bandwidth requirement may be addressed using large register files, or using multiple memory or cache modules. Unfortunately, these implementations may be complex and may involve large power consumption.

### BRIEF DESCRIPTION OF THE DRAWINGS

The subject matter regarded as the invention is particularly pointed out and distinctly claimed in the concluding portion of the specification. The invention, however, both as to organization and method of operation, together with features and advantages thereof, may best be understood by reference to the following detailed description when read with the accompanied drawings in which:

FIG. 1 is a schematic block diagram illustration of a computing system able to access a memory in accordance with an embodiment of the invention;

FIG. 2 is a schematic block diagram illustration of a computing system able to access a memory in accordance with another embodiment of the invention;

FIG. 3 is a schematic block diagram illustration of a processor core able to access a memory in accordance with an embodiment of the invention;

FIG. 4 is a schematic block diagram illustration of memory access functionality in accordance with an embodiment of the invention; and

FIG. 5 is a schematic flow-chart of a method of accessing a memory in accordance with an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, units and/or circuits have not been described in detail so as not to obscure the invention.

Embodiments of the invention may be used in a variety of applications. Although embodiments of the invention are not limited in this regard, embodiments of the invention may be used in conjunction with many apparatuses, for example, a computer, a computing platform, a personal computer, a desktop computer, a mobile computer, a laptop computer, a notebook computer, a personal digital assistant (PDA) device, a tablet computer, a server computer, a network, a wireless device, a wireless station, a wireless communication device, or the like. Embodiments of the invention may be used in various other apparatuses, devices, systems and/or networks.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and/or “a plurality” as used herein may include, for example, “multiple” or “two or more”. The terms “plurality” and/or “a plurality” may be used herein describe two or more components, devices, elements, parameters, or the like. For example, a plurality of elements may include two or more elements.

Although portions of the discussion herein may relate, for demonstrative purposes, to “words” which may be read, stored, buffered or gathered, embodiments of the invention are not limited in this regard. For example, other data types or data items may be read, stored, buffered or gathered, e.g., strings, sets of words, operands, op-codes, bits, bytes, sets of bits or bytes, vectors, cells or items of a table or a matrix, columns or rows of a table or a matrix, or the like.

Although portions of the discussion herein may relate, for demonstrative purposes, to a “single instruction multiple data (SIMD) word” which may be gathered, formed, processed or intended for processing, embodiments of the invention are not limited in this regard. For example, other data types or data items may be gathered, formed, processed or intended for processing, e.g., data blocks, strings, words having various sizes, sets of words, operands, op-codes, sets of bits or bytes, vectors, cells or items of a table or a matrix, columns or rows of a table or a matrix, or the like.

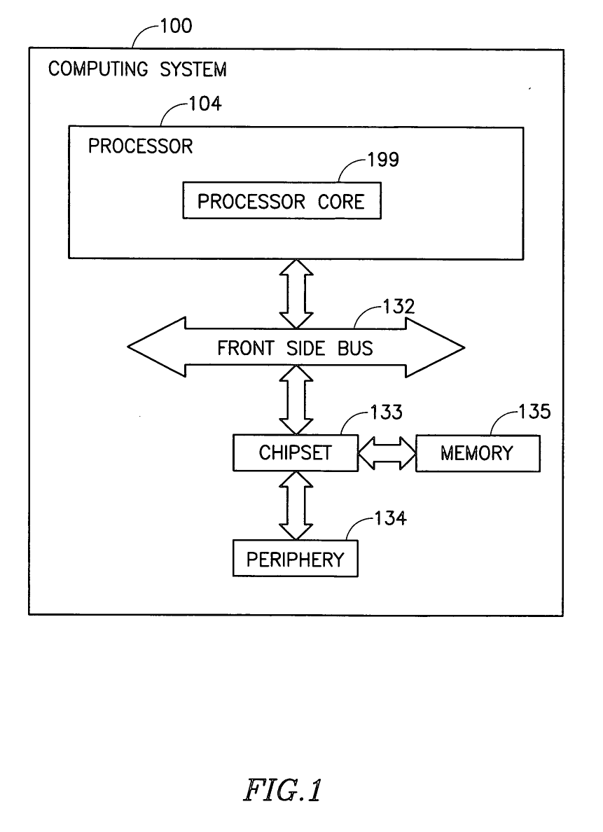

FIG. 1 schematically illustrates a computing system 100 able to access a memory in accordance with some embodiments of the invention. Computing system 100 may include or may be, for example, a computing platform, a processing platform, a personal computer, a desktop computer, a mobile computer, a laptop computer, a notebook computer, a terminal, a workstation, a server computer, a PDA device, a tablet computer, a network device, a cellular phone, or other suitable computing and/or processing and/or communication device.

Computing system 100 may include a processor 104, for example, a central processing unit (CPU), a digital signal processor (DSP), a microprocessor, a host processor, a controller, a plurality of processors or controllers, a chip, a microchip, one or more circuits, circuitry, a logic unit, an integrated circuit (IC), an application-specific IC (ASIC), or any other suitable multi-purpose or specific processor or controller. Processor 104 may include one or more processor cores, for example, a processor core 199. Processor core 199 may optionally include, for example, an in-order module or subsystem, an out-of-order module or subsystem, an execution block or subsystem, one or more execution units (EUs), one or more adders, multipliers, shifters, logic elements, combination logic elements, AND gates, OR gates, NOT gates, XOR gates, switching elements, multiplexers, sequential logic elements, flip-flops, latches, transistors, circuits, sub-circuits, and/or other suitable components.

Computing system 100 may further include a shared bus, for example, a front side bus (FSB) 132. For example, FSB 132 may be a CPU data bus able to carry information between processor 104 and one or more other components of computing system 100.

In some embodiments, for example, FSB 132 may connect between processor 104 and a chipset 133. The chipset 133 may include, for example, one or more motherboard chips, e.g., a “northbridge” and a “southbridge”, and/or a firmware hub. Chipset 133 may optionally include connection points, for example, to allow connection(s) with additional buses and/or components of computing system 100.

Computing system 100 may further include one or more peripheries 134, e.g., connected to chipset 133. For example, periphery 134 may include an input unit, e.g., a keyboard, a keypad, a mouse, a touch-pad, a joystick, a stylus, a microphone, or other suitable pointing device or input device; and/or an output unit, e.g., a cathode ray tube (CRT) monitor, a liquid crystal display (LCD) monitor, a plasma monitor, other suitable monitor or display unit, a speaker, or the like; and/or a storage unit, e.g., a hard disk drive, a floppy disk drive, a compact disk (CD) drive, a CD-recordable (CD-R) drive, a digital versatile disk (DVD) drive, or other suitable removable and/or fixed storage unit. In some embodiments, for example, the aforementioned output devices may be coupled to chipset 133, e.g., in the case of a computing system 100 utilizing a firmware hub.

Computing system 100 may further include a memory 135, e.g., a system memory connected to chipset 133 via a memory bus. Memory 135 may include, for example, a random access memory (RAM), a read only memory (ROM), a dynamic RAM (DRAM), a synchronous DRAM (SD-RAM), a flash memory, a volatile memory, a non-volatile memory, a cache memory, a buffer, a short term memory unit, a long term memory unit, or other suitable memory units or storage units. In some embodiments, processor core 199 may access memory 135 as described in detail herein. Computing system 100 may optionally include other suitable hardware components and/or software components.

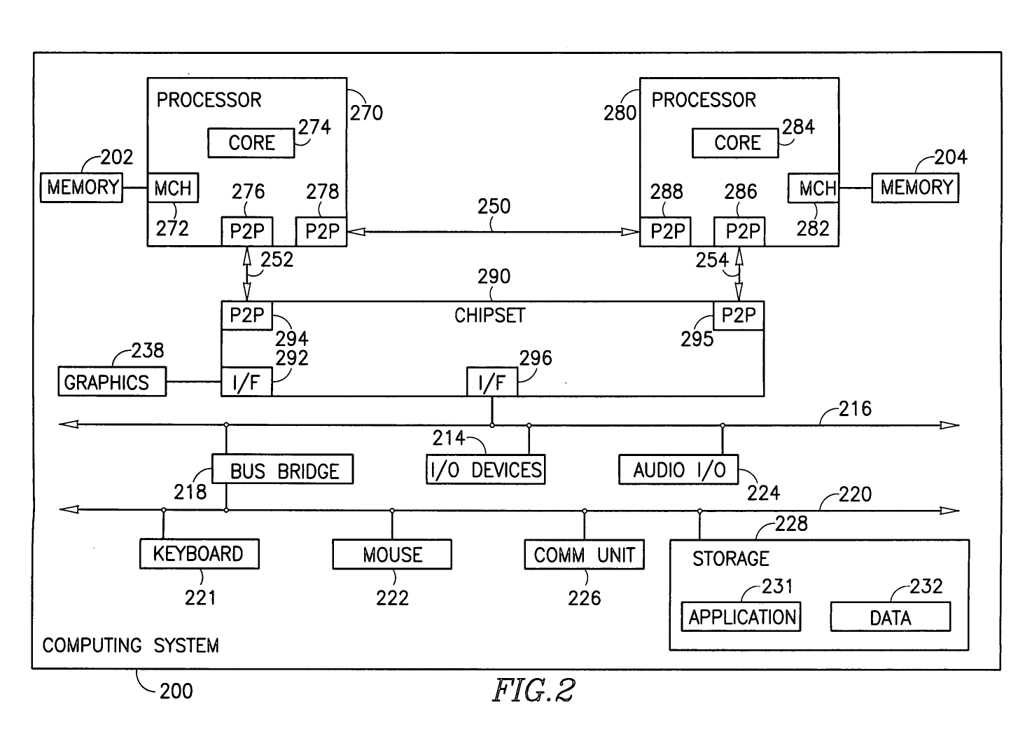

FIG. 2 schematically illustrates a computing system 200 able to access a memory in accordance with some embodiments of the invention. Computing system 200 may include or may be, for example, a computing platform, a processing platform, a personal computer, a desktop computer, a mobile computer, a laptop computer, a notebook computer, a terminal, a workstation, a server computer, a PDA device, a tablet computer, a network device, a cellular phone, or other suitable computing and/or processing and/or communication device.

Computing system 200 may include, for example, a point-to-point busing scheme having one or more processors, e.g., processors 270 and 280; memory units, e.g., memory units 202 and 204; and/or one or more input/output (I/O) devices, e.g., I/O device(s) 214, which may be interconnected by one or more point-to-point interfaces.

Processors 270 and/or 280 may include, for example, processor cores 274 and 284, respectively. In some embodiments, processor cores 274 and/or 284 may utilize data validity tracking as described in detail herein.

Processors 270 and 280 may further include local memory channel hubs (MCHs) 272 and 282, respectively, for example, to connect processors 270 and 280 with memory units 202 and 204, respectively. Processors 270 and 280 may exchange data via a point-to-point interface 250, e.g., using point-to-point interface circuits 278 and 288, respectively.

Processors 270 and 280 may exchange data with a chipset 290 via point-to-point interfaces 252 and 254, respectively, for example, using point-to-point interface circuits 276, 294, 286, and 295. Chipset 290 may exchange data with a high-performance graphics circuit 238, for example, via a high-performance graphics interface 292. Chipset 290 may further exchange data with a bus 216, for example, via a bus interface 296. One or more components may be connected to bus 216, for example, an audio I/O unit 224, and one or more input/output devices 214, e.g., graphics controllers, video controllers, networking controllers, or other suitable components.

Computing system 200 may further include a bus bridge 218, for example, to allow data exchange between bus 216 and a bus 220. For example, bus 220 may be a small computer system interface (SCSI) bus, an integrated drive electronics (IDE) bus, a universal serial bus (USB), or the like. Optionally, additional I/O devices may be connected to bus 220. For example, computing system 200 may further include, a keyboard 221, a mouse 222, a communications unit 226 (e.g., a wired modem, a wireless modem, a network card or interface, or the like), a storage device 228 (e.g., able to store a software application 231 and/or data 232), or the like.

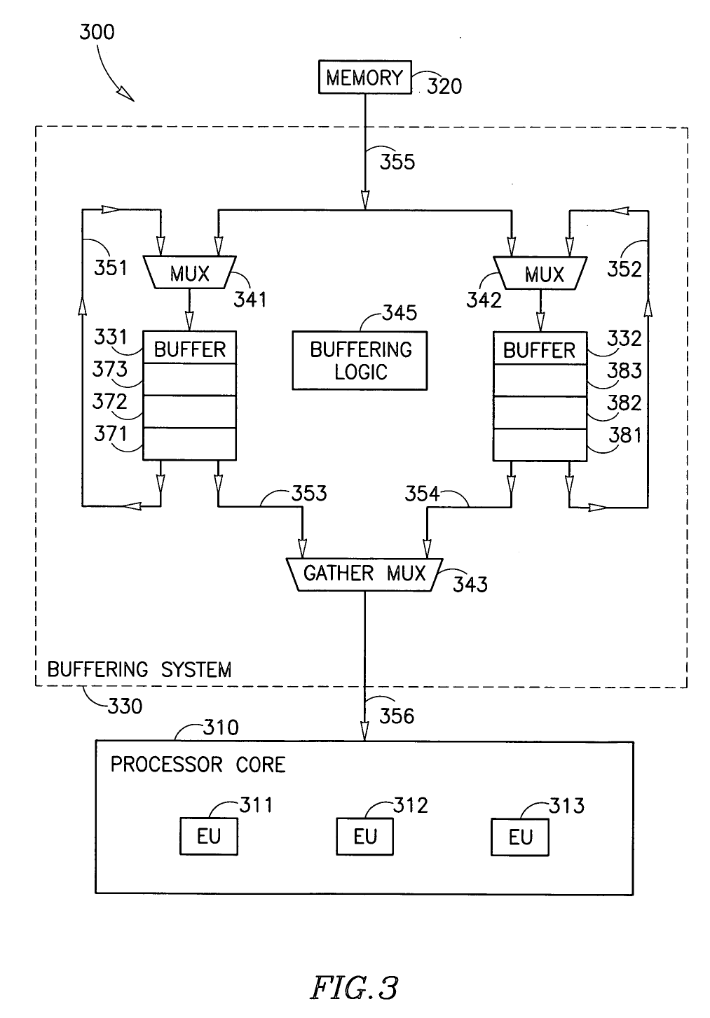

FIG. 3 schematically illustrates a subsystem 300 able to access a memory in accordance with some embodiments of the invention. Subsystem 300 may be, for example, a subsystem of computing system 100 of FIG. 1, a subsystem of computing system 200 of FIG. 2, a subsystem of another computing system or computing platform, or the like.

Subsystem 300 may include, for example, a processor core 310, a memory 320, and a buffering system 320. Processor core 310 may include, for example, one or more EUs, for example, three EUs 311-313. Memory 320 may include, for example, a local memory, a cache memory, a RAM memory, a memory accessible through a direct connection, a memory accessible through a bus, or the like.

Buffering system 330 may include one or more buffers, for example, buffers 331-332. For example, buffer 331 and/or buffer 332 may be a first in first out (FIFO) buffer and/or a cyclic buffer or a circular buffer. In some embodiments, for example, buffer 331 and/or buffer 332 may be able to store multiple lines of data, e.g., a pre-defined number of lines having a pre-defined (e.g., eight) data words per line. For example, buffer 331 may include multiple lines, e.g., lines 371-373, and buffer 332 may include multiple lines, e.g., lines 381-383. In one embodiment, optionally, the size or dimensions (e.g., number of lines per buffer, or number of words or bits per line) of buffer 331 may be substantially identical to the size or dimensions of buffer 332, respectively. In another embodiment, optionally, for example, the size or dimensions of buffer 331 may be different from the size or dimensions of buffer 332, respectively. In some embodiments, for example, the size or dimensions of buffer 331 and/or buffer 332 may be set or configured, for example, to accommodate certain functionalities or properties of buffering system 330 in various implementations.

Buffering system 330 may further include one or more multiplexers, e.g., multiplexers 341-343, which may be, for example, able to gather data. Buffering system 330 may optionally include a buffering logic 345, for example, a programmable or a dynamically configurable logic unit able to control the operations of buffering subsystem 330, able to control the characteristics or operation of buffers 331-332, or the like.

Buffering system 330 may read data from memory 320, for example, through a link 355. In some embodiments, for example, link 355 may transfer data from memory 320 to buffering system 330 in discrete portions, e.g., such that a discrete portion may correspond to a width or a number of bits of a data line of memory 320.

Data read from memory 320 may be stored, alternately (or using another regular or pre-defined storage scheme), in buffers 331 and 332. For example, a first data item (e.g., a first data line) may be read from memory 320 and stored in line 371 of buffer 331; a second data item (e.g., a second data line) may be read from memory 320 and stored in line 381 of buffer 332; a third data item (e.g., a third data line) may be read from memory 320 and stored in line 372 of buffer 331; a fourth data item (e.g., a fourth data line) may be read from memory 320 and stored in line 382 of buffer 332; and so on.

Data read from memory 320 may be stored in buffer 331 using a FIFO scheme, and alternately, in buffer 332 using a FIFO scheme. For example, data items may be stored in buffer 331 until buffer 331 is substantially full, and a consecutive data item intended for buffering in buffer 331 may replace a first-written (e.g., an oldest written) data item of buffer 331. Similarly, data items may be stored in buffer 332 until buffer 332 is substantially full, and a consecutive data item intended for buffering in buffer 332 may replace a first-written (e.g., an oldest written) data item of buffer 332.

Gather multiplexer 343 may gather data from buffer 331 and/or buffer 332, e.g., using links 353 and/or 354, respectively, for example, to form a single instruction multiple data (SIMD) word for processing by processor core 310 or by an EU thereof, or to form two SIMD operands for processing by processor core 310 or by an EU thereof. For example, gather multiplexer 343 may form a SIMD word from one or more words stored in line 371 of buffer 331 and from one or more words stored in line 381 of buffer 332. In some embodiments, for example, a link 356 may transfer data (e.g., a formed SIMD word, or two SIMD operands) from buffering system 320 to processor core 310 or to an EU thereof in discrete portions, e.g., such that a discrete portion may correspond to a width, a number of bits or a number of words of a SIMD word, or a number of words required or utilized as operands by one or more EUs 311-313.

In some embodiments, the operation of buffer 331 may be controllable or programmable, e.g., utilizing buffering logic 345. For example, buffering logic 345 may optionally select, using multiplexer 341, to re-use a data item stored in buffer 331, to maintain or to avoid discarding a firstly-written or an oldest-written data item stored in buffer 331, or the like. In some embodiments, for example, buffering logic 345 may selectively or temporarily operate buffer 331 as a cyclic buffer or as a non-FIFO buffer, e.g., such that a data item transferred out from buffer 331 to multiplexer 343 through link 353, is further received as input into multiplexer 341 (e.g., using a link 351), for example, in addition to or instead of an input from memory 320.

Similarly, in some embodiments, the operation of buffer 332 may be controllable or programmable, e.g., utilizing buffering logic 345. For example, buffering logic 345 may optionally select, using multiplexer 342, to re-use a data item stored in buffer 332, to maintain or to avoid discarding a firstly-written or an oldest-written data item stored in buffer 332, or the like. In some embodiments, for example, buffering logic 345 may selectively or temporarily operate buffer 332 as a cyclic buffer or as a non-FIFO buffer, e.g., such that a data item transferred out from buffer 332 to multiplexer 343 through link 354, is further received as input into multiplexer 342 (e.g., using a link 352), for example, in addition to or instead of an input from memory 320.

In some embodiments, buffering system 330 may thus re-use a data item previously read from memory 320, and stored in buffers 331 or 332, for example, in order to form more than one SIMD word, in order to form multiple (e.g., consecutive) SIMD words, or the like. For example, a first data line (e.g., a first set of eight words) may be read from memory 320 and stored in line 371 of buffer 331; and a second data line (e.g., a second set of eight words) may be read from memory 320 and stored in line 381 of buffer 332. Gather multiplexer 343 may form two eight-word SIMD operands from nine words, e.g., from the first set of eight words stored in line 371 of buffer 331, and from one word (e.g., the first word) out of the second set of eight words stored in line 381 of buffer 332. The two SIMD operands may be transferred to processor core 310, or to an EU thereof, for processing. A third data line (e.g., a third set of eight words) may be read from memory 320 and stored in line 372 of buffer 331. Gather multiplexer 343 may form a second set of two SIMD operands, e.g., two sets of consecutive eight words out of nine words, for example, from the second set of eight words stored in line 381 of buffer 332, and from one word (e.g., the first word) out of the third set of words stored in line 372 of buffer 331. The second set of SIMD operands may be transferred to processor core 310, or to an EU thereof, for processing. A fourth data line (e.g., a fourth set of eight words) may be read from memory 320 and stored in line 382 of buffer 332. Gather multiplexer 343 may form a third set of two SIMD operands, e.g., two sets of consecutive eight words out of nine words, for example, from the third set of eight words stored in line 372 of buffer 331, and from one word (e.g., the first word) out of the fourth set of words stored in line 382 of buffer 332. The third set of SIMD operands may be transferred to processor core 310, or to an EU thereof, for processing. Other suitable buffering schemes may be used by buffering system 320 to re-use one or more data lines (or portions thereof) in order to form multiple SIMD words or multiple sets of SIMD operands, e.g., a first SIND word and a second (e.g., consecutive or subsequent) SIMD word.

The architecture described herein, e.g., utilizing the buffering system 330, may be used in conjunction with various applications and/or algorithms, for example, convolution, image frame enhancement, video enhancement, image filter algorithms, vector processors, matrix multiplications, matrix operations, Gaussian decimation filter algorithms, global derivative calculations, finite input response (FIR) calculations, fast Fourier transform (FFT) algorithms, algorithms that use non-aligned data, algorithms that use misaligned data, algorithms that use SIMD word data, algorithms that use data items having a size greater (e.g., 1.125 times) or smaller (e.g., 0.875 times) than the size of a single memory line, algorithms that use data items having a size greater (e.g., 2.25 times) or smaller (e.g., 1.75 times) than an integer multiple of a single memory line, algorithms that use a first portion of a data line in a first iteration and a second portion of that data line in a second iteration, algorithms that use a first portion of a data line to form a first SIMD word and a second portion of that data line to form a second SIMD word, algorithms that utilize data gathered or polled in accordance with a regular or repeating pattern, algorithms that utilize data gathered or polled in accordance with a stride-based access pattern, algorithms that utilize or exhibit one or more regular access patterns, algorithms that utilize or exhibit re-use of data from previously fetched memory lines, numeric accelerators, streaming data accelerator mechanisms, algorithms that consume or require a large memory bandwidth, algorithms that exhibit a regular access pattern, and/or other suitable calculations or algorithms.

In some embodiments, buffering logic 345 may be programmable and/or dynamically configurable to allow selective or modular control of the operations of buffering subsystem 330 and/or the characteristics or operation of buffers 331-332. For example, buffering logic may be programmable and/or configurable by a software application, an image processing application, a video processing application, a low level programming language, a code, a compiled code, a compiler, a programmer, an online compilation process, an online just-in-time (JIT) compiler or process, or the like. Optionally, in some embodiments, for example, buffering logic 345 may switch among multiple pre-defined logic modules, multiple pre-configured sets of parameters, or multiple pre-defined modes of operation of buffering system 330 or buffers 331-332.

In some embodiments, for example, buffering logic 345 may be programmed and/or configured such that buffer 331 operates in a first mode, e.g., a “FIFO mode”, in which buffer 331 receives as input a subsequent memory line read from memory 320, which may overwrite or replace a firstly-written or oldest-written buffer line (e.g., line 371); whereas buffer 332 operates in a second mode, e.g., a “cyclic mode”, in which buffer 332 receives as input the content of a previously-used line (e.g., line 381) of buffer 332, or vice versa. In some embodiments, for example, the programming or configuration of buffering logic 345 may control the operation of gather multiplexer 343, e.g., the method or scheme used for gathering and preparing a SIMD word from buffers 331 and/or 332. In some embodiments, the programming or configuration of buffering logic 345 may take into account, or may be based on, for example, a pattern of data utilization, data collection or data gathering by a certain module or application.

Some embodiments may be used in conjunction with in-order execution; other embodiments may be used in conjunction with out-of-order execution, e.g., optionally using adjustment of an allocation phase and/or a rename phase.

In some embodiments, buffering logic 345, or the programming and/or configuration thereof, may be implemented using one or more registers, e.g., control register(s) associated with buffer 331 and/or buffer 332, control register(s) associated with gather multiplexer 343, control register(s) associated with multiplexer 341 and/or multiplexer 342, or the like.

Although portions of the discussion herein relate, for demonstrative purposes, to buffering system 320 having two buffers 331-332, other buffering mechanisms may be used. For example, some embodiments may utilize a single-buffer mechanism, a double-buffer mechanism, a triple or quadruple buffer mechanism, a multi-buffer mechanism, a mechanism having FIFO buffer(s) and/or cyclic buffer(s), or the like.

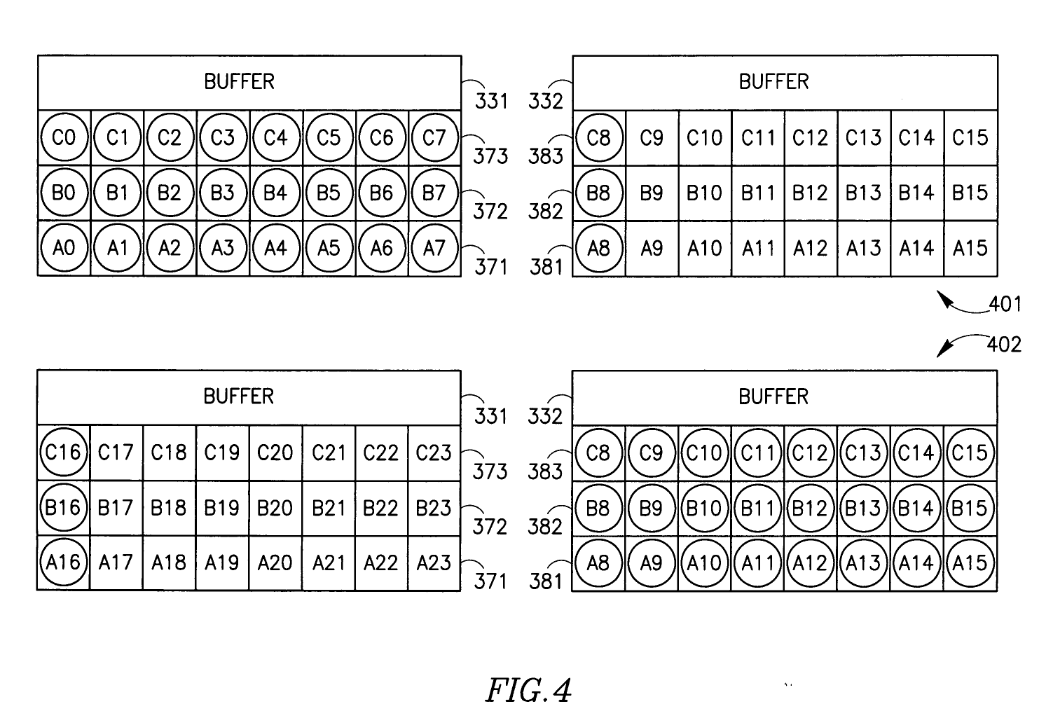

FIG. 4 schematically illustrates memory access functionality in accordance with some embodiments of the invention. Portion 401 demonstrates the content of buffers 331-332 of FIG. 3 at a first iteration of memory access, and portion 402 demonstrates the content of buffers 331-332 of FIG. 3 at a second (e.g., consecutive or subsequent) iteration of memory access.

As demonstrated in portion 401, at the first iteration of memory access, memory lines may be read (e.g., from memory 320 of FIG. 3) and stored alternately in buffers 331-332. For example, a first set of eight words, denoted A0 through A7, may be read and stored in line 371 of buffer 331; a second set of eight words, denoted A8 through A15, may be read and stored in line 381 of buffer 332; a third set of eight words, denoted B0 through B7, may be read and stored in line 372 of buffer 331; a fourth set of eight words, denoted B8 through B15, may be read and stored in line 382 of buffer 332; a fifth set of eight words, denoted C0 through C7, may be read and stored in line 373 of buffer 331; and a sixth set of eight words, denoted C8 through C15, may be read and stored in line 383 of buffer 332.

The content of buffers 331-332 may be used, for example, to form three sets of SIMD operands, e.g., such that a set corresponds to nine words, for example, a first group of eight consecutive words (a first SIMD operand) and a second group of eight consecutive words (a second SIMD operand). The three sets of SIMD operands may include, for example, a first set of SIMD operands formed of words A0 through A7 of line 371 of buffer 331 and word A8 of line 381 of buffer 332; a second set of SIMD operands formed of words B0 through B7 of line 372 of buffer 331 and word B8 of line 382 of buffer 332; and a third set of SIMD operands formed of words C0 through C7 of line 373 of buffer 331 and word C8 of line 383 of buffer 332. Words stored in buffers 331-332 that are used to form the three sets of SIMD operands in the first iteration are shown circled; whereas words stored in buffers 331-332 that are not used to form the three sets of SIMD operands in the first iteration are shown non-circled. The three SIMD words (e.g., the three sets of SIMD operands) formed in the first iteration may be processed by one or more EUs, for example, by EUs 311-313 of FIG. 1.

Upon transfer of the formed SIMD word(s) to the EU(s), as demonstrated in FIG. 4, the content of buffer 332 may be maintained, e.g., substantially unchanged. For example, it may be determined (e.g., by buffering logic 345 of FIG. 3) that only a small portion of the words stored in buffer 332 were used in the first iteration, that a large portion of the words stored in buffer 332 were not used in the first iteration, or that a pre-determined or large portion of the words stored in buffer 332 are expected to be used in the second (e.g., consecutive or subsequent) iteration. Based on the determination, the content of buffer 332 may be maintained in the first iteration, whereas the content of buffer 331 may be updated, replaced and/or overwritten.

As demonstrated in portion 402, at the second iteration of memory access, memory lines may be read (e.g., from memory 320 of FIG. 3) and stored in buffer 331. For example, a seventh set of eight words, denoted A16 through A23, may be read and stored in line 371 of buffer 331; an eighth set of eight words, denoted B16 through B23, may be read and stored in line 372 of buffer 331; and a ninth set of eight words, denoted C16 through C23, may be read and stored in line 373 of buffer 331.

The content of buffers 331-332 may be used, for example, to form three sets of SIMD operands, e.g., such that a set corresponds to nine words, for example, a first group of eight consecutive words (a first SIMD operand) and a second group of eight consecutive words (a second SIMD operand). The three sets of SIMD operands may include, for example, a first set of SIMD operands formed of words A8 through A15 of line 381 of buffer 332 and word A16 of line 371 of buffer 331; a second set of SIMD operands formed of words B8 through B15 of line 382 of buffer 332 and word B16 of line 372 of buffer 331; and a third set of SIMD operands formed of words C8 through C15 of line 383 of buffer 332 and word C16 of line 373 of buffer 331. Words stored in buffers 331-332 that are used to form the three sets of SIMED operands in the second iteration are shown circled; whereas words stored in buffers 331-332 that are not used to form the three sets of SIMD operands in the second iteration are shown non-circled. The three SIMD words (e.g., the three sets of SIMD operands) formed in the second iteration may be processed by one or more EUs, for example, by EUs 311-313 of FIG. 1.

As demonstrated in FIG. 4, instead of reading six sets of eight words in order to gather three sets of SIMD operands, and then reading another six sets of eight words in order to gather the other three sets of SIMD operands, a smaller or reduced number of readings may be performed. For example, six sets of eight words may be used to gather three sets of SIMD operands; three sets of the read sets may be maintained (e.g., in buffer 332) for re-use; three sets of eight words may be read and stored (e.g., in buffer 331); and the recently-read three sets, together with the previously-read and maintained three sets, may be used to form other three sets of SIMD operands. For example, the buffer architecture (e.g., single-buffer, double-buffer, multi-buffer) described herein may be utilized to maintain at least a portion of data (e.g., a non-used portion) that is read at a first iteration for use (e.g., to form SIMD operands) at a second iteration (e.g., to form other SIMD operands), thereby avoiding, eliminating or reducing the need to re-read at least a portion of previously-read data.

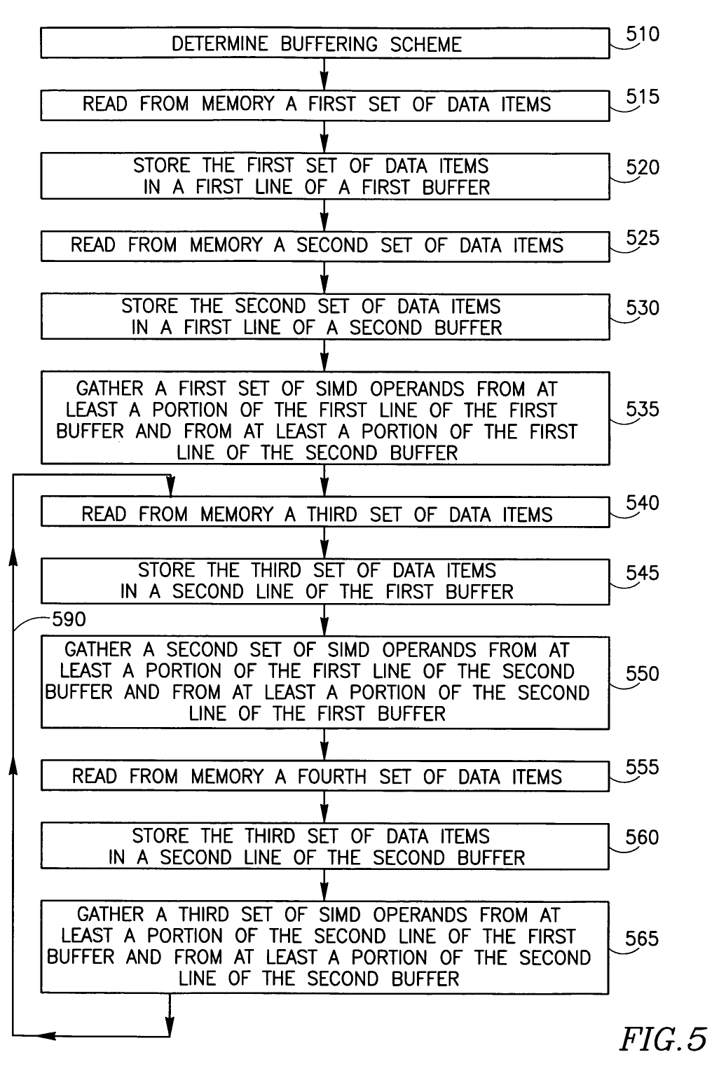

FIG. 5 is a schematic flow-chart of a method of accessing a memory in accordance with some embodiments of the invention. Operations of the method may be implemented, for example, by buffering system 330 of FIG. 3, and/or by other suitable computers, processors, components, devices, and/or systems.

As indicated at box 510, the method may optionally include, for example, determining a buffering scheme. This may be performed, for example, based on a regular pattern of data access, a regular pattern of data collection or gathering, a regular pattern of re-use of previously-fetched or previously-read data, or the like.

As indicated at box 515, the method may optionally include, for example, reading a first set of data items (e.g., words) from a memory.

As indicated at box 520, the method may optionally include, for example, storing the first set of data items in a first line of a first buffer.

As indicated at box 525, the method may optionally include, for example, reading a second set of data items from the memory.

As indicated at box 530, the method may optionally include, for example, storing the second set of data items in a first line of a second buffer.

As indicated at box 535, the method may optionally include, for example, gathering or assembling a data block requested by a processor, e.g., a first set of SIMD operands for processing, from a suitable combination of buffered data. In one embodiment, for example, the set of SIMD operands may be gathered, e.g., from at least a portion of the first line of the first buffer and from at least a portion of the first line of the second buffer.

As indicated at box 540, the method may optionally include, for example, reading a third set of data items from the memory.

As indicated at box 545, the method may optionally include, for example, storing the third set of data items in a second line of the first buffer.

As indicated at box 550, the method may optionally include, for example, gathering of assembling a second set of SIMD operands for processing from a suitable combination of buffered data. In one embodiment, for example, the set of SIMD operands may be gathered, e.g., from at least a portion of the first line of the second buffer and from at least a portion of the second line of the first buffer.

As indicated at box 555, the method may optionally include, for example, reading a fourth set of data items from the memory.

As indicated at box 560, the method may optionally include, for example, storing the fourth set of data items in a second line of the second buffer.

As indicated at box 565, the method may optionally include, for example, gathering or assembling a third set of SIMD operands for processing from a suitable combination of buffered data. In one embodiment, for example, the set of SIMD operands may be gathered, e.g., from at least a portion of the second line of the first buffer and from at least a portion of the second line of the second buffer.

As indicated by arrow 590, the method may optionally include, for example, repeating some or all of the above operations.

Other suitable operations or sets of operations may be used in accordance with embodiments of the invention.

Although portions of the discussion herein may relate, for demonstrative purposes, to gathering of two SIMD operands from buffered data, embodiments of the invention are not limited in this regard, and other suitable one or more data items (or sets of data items, or portions of data items) intended for processing may be gathered from buffered data or from portions (e.g., consecutive portions and/or non-consecutive portions) of buffered data.

Although portions of the discussion herein may relate, for demonstrative purposes, to gathering of data items (e.g., two SIMD operands) from two lines of buffered data, embodiments of the invention are not limited in this regard. For example, data items may be gathered from other number of lines or portions (e.g., consecutive portions and/or non-consecutive portions) of buffered data.

Although portions of the discussion herein may relate, for demonstrative purposes, to alternately storing and/or alternately buffering data lines in two buffers, embodiments of the invention are not limited in ibis regard. For example, in some embodiments, other number of buffers may be used, non-alternate storage schemes may be used, or other suitable gathering or assembly schemes may be used to form data items (e.g., SIMD operands) from various portions of buffered data.

Some embodiments of the invention may be implemented by software, by hardware, or by any combination of software and/or hardware as may be suitable for specific applications or in accordance with specific design requirements. Embodiments of the invention may include units and/or sub-units, which may be separate of each other or combined together, in whole or in part, and may be implemented using specific, multi-purpose or general processors or controllers, or devices as are known in the art. Some embodiments of the invention may include buffers, registers, stacks, storage units and/or memory units, for temporary or long-term storage of data or in order to facilitate the operation of a specific embodiment.

Some embodiments of the invention may be implemented, for example, using a machine-readable medium or article which may store an instruction or a set of instructions that, if executed by a machine, for example, by processor core 310, by other suitable machines, cause the machine to perform a method and/or operations in accordance with embodiments of the invention. Such machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit (e.g., memory unit 135 or 202), memory device, memory article, memory medium, storage device, storage article, storage medium and/or storage unit, for example, memory, removable or non-removable media, erasable or non-erasable media, writeable or re-writeable media, digital or analog media, hard disk, floppy disk, compact disk read only memory (CD-ROM), compact disk recordable (CD-R), compact disk re-writeable (CD-RW), optical disk, magnetic media, various types of digital versatile disks (DVDs), a tape, a cassette, or the like. The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, BASIC, Pascal, Fortran, Cobol, assembly language, machine code, or the like.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. An apparatus comprising:
at least one buffer to store a data line read from a memory; and
a gatherer to store at least a portion of said data line and at least a portion of a previously read data line stored in said at least one buffer.

2. The apparatus of claim 1, wherein said at least one buffer comprises a plurality of buffers to store data from a plurality of respective data lines read from said memory.

3. The apparatus of claim 1, wherein said at least one buffer comprises a first in first out buffer that is able to store a new data line read from said memory by overwriting a previously stored data line.

4. The apparatus of claim 1, comprising a buffering logic to control a mode of operation of said at least one buffer.

5. The apparatus of claim 4, wherein said buffering logic is to control said at least one buffer to operate in a mode of operation selected from a group consisting of: a first in first out mode of operation of said at least one buffer, and a cyclic mode of operation of said at least one buffer.

6. The apparatus of claim 4, wherein said buffering logic is to determine a pattern of memory access and to control said at least one buffer based on said pattern.

7. The apparatus of claim 6, wherein said pattern comprises regular memory access to non-aligned data.

8. The apparatus of claim 6, wherein said pattern comprises reading a first data line from said memory, gathering a first data block for processing using a first portion of said first data line, re-reading said first data line from said memory, and gathering a second data block for processing using a second portion of said first data line.

9. The apparatus of claim 1, wherein said gatherer is to prepare a set of single instruction multiple data operands from at least said portion of said data line and at least said portion of said previously read data line stored in said at least one buffer.

10. The apparatus of claim 4, wherein said buffering logic is to control said mode of operation of said at least one buffer based on a determination that a processor of said apparatus is to execute a convolution algorithm using said data line.

11. A method comprising:
storing in at least one buffer a data line read from a memory; and
preparing a data block for processing by combining at least a portion of said data line and at least a portion of a previously read data line stored in said at least one buffer.

12. The method of claim 11, wherein storing comprises:
storing data read from a plurality of data lines of said memory in a plurality of respective buffers.

13. The method of claim 11, wherein storing comprises:
storing in said at least one buffer a new data line read from said memory by overwriting a previously stored data line.

14. The method of claim 11, further comprising:
controlling a mode of operation of said at least one buffer in accordance with a buffering logic.

15. The method of claim 14, wherein controlling comprises:
controlling said at least one buffer to operate in a mode of operation selected from a group consisting of: a first in first out mode of operation of said at least one buffer, and a cyclic mode of operation of said at least one buffer.

16. The method of claim 14, comprising:
determining a pattern of memory access; and
controlling said at least one buffer based on said pattern.

17. The method of claim 16, wherein determining comprises:
determining a pattern of regular memory access to non-aligned data.

18. The method of claim 16, wherein determining comprises:
determining a pattern of reading a first data line from said memory, gathering a first data block for processing using a first portion of said first data line, re-reading said first data line from said memory, and gathering a second data block for processing using a second portion of said first data line.

19. The method of claim 11, wherein preparing the data block comprises forming a set of single instruction multiple data operands.

20. The method of claim 14, wherein controlling comprises:
controlling said mode of operation of said at least one buffer based on a determination that a processor is to execute a convolution algorithm using said data line.

21. A system comprising:
a dynamic random access memory;
at least one buffer to store a data line read from said memory; and
a gatherer to prepare a first data block for processing from at least a first portion of said data line stored in said at least one buffer, and to prepare a second data block for processing from at least a second portion of said data line stored in said at least one buffer.

22. The system of claim 21, wherein said at least one buffer comprises a plurality of buffers to store data from a plurality of respective data lines read from said memory, and wherein said gatherer is to prepare said first and second data blocks from said plurality of data lines stored in said plurality of buffers.

23. The system of claim 21, wherein said at least one buffer comprises a first in first out buffer that is able to overwrite a previously stored data line with a new data line read from said memory.

24. The system of claim 21, wherein said first data block comprises a first set of single instruction multiple data operands, and wherein said second data block comprises a second set of single instruction multiple data operands.

25. The system of claim 21, comprising a buffering logic to modify a mode of operation of said at least one buffer based on a determined pattern of memory access.

26. The system of claim 24, wherein said buffering logic is to control said at least one buffer to operate in a cyclic mode of operation if said buffering logic determines that at least a portion of a previously read data line is expected to be re-used.

27. The system of claim 25, wherein said pattern comprises regular memory access to non-aligned data.

28. The system of claim 25, wherein said pattern comprises reading a first data line from said memory, forming a first data block for processing using a first portion of said first data line, re-reading said first data line from said memory, and forming a second data block for processing using a second portion of said first data line.

29. The system of claim 21, wherein said gatherer is to prepare a set of single instruction multiple data operands from at least said portion of said data line and at least portion of a previously read data line stored in said at least one buffer.

30. The system of claim 25, wherein said buffering logic is to control said mode of operation of said at least one buffer based on a determination that a processor of said apparatus is to execute a convolution algorithm using said data line.
